(19) United States
(12) Patent Application Publication
(10) Pub. No.: US 2016/0075335 A1
(43) Pub. Date: Mar. 17, 2016

(54) METHOD FOR ADAPTIVE CRUISE CONTROL OF A VEHICLE USING SWARM ALGORITHM

(71) Applicant: FORD GLOBAL TECHNOLOGIES, LLC, Dearborn, MI (US)

(72) Inventors: Christoph ARNDT, Moerlen Rheinland-Pfalz (DE); Uwe GUSSEN, Huertgenwald (DE); Frederic STEFAN, Aachen (DE)

(21) Appl. No.: 14/856,003

(22) Filed: Sep. 16, 2015

(30) Foreign Application Priority Data
Sep. 16, 2014 (DE) 102014218565.3

(51) Int. Cl. B60W 30/165; B60W 10/04; B60W 10/20; B60W 10/18; B60W 40/04; B60W 50/00

(52) U.S. Cl. CPC B60W 30/165; B60W 40/04; B60W 50/00; B60W 10/20; B60W 10/18; B60W 10/04; B60W 50/0097; B60W 2050/0017; B60W 2550/302; B60W 2550/306; B60W 2550/308

(57) ABSTRACT

A method of operating an adaptive cruise control (ACC) system of a host vehicle includes operating a sensor onboard the host vehicle to determine respective dynamic state variables of a leading vehicle forward of the host vehicle and of a plurality of third vehicles in the vicinity of the host vehicle, and using a swarm algorithm to process the dynamic state variables of the third vehicles to predict future movements thereof Acceleration/deceleration of the host is controlled by the ACC based upon the variables and the predicted future movements of the third vehicles. The third vehicles may be sub-divided into first and second and respective first and second swarm algorithms applied thereto and later combined to predict future movements of the third vehicles. Third vehicles located ahead of the leading vehicle may be detected using radar signals that are reflected off of the road surface beneath the leading vehicle.

### CROSS-REFERENCE TO RELATED APPLICATIONS

This application claims foreign priority benefits under 35 U.S.C. §119(a)-(d) to DE 10 2014 218 565.3 filed Sep. 16, 2014, which is hereby incorporated by reference in its entirety.

### TECHNICAL FIELD

The invention relates to a method and a device for adaptive cruise control of a vehicle using a swarm algorithm.

### BACKGROUND

Adaptive cruise control (ACC) may be part of the optional extras of a motor vehicle that assist the driver whilst reducing his stress level and increasing the driving comfort. In a typical ACC system, a vehicle that is travelling directly ahead of (i.e., in the same lane) of the ACC-equipped vehicle (the “leading vehicle”) is monitored, the relative velocity, distance, and acceleration between the vehicle that is equipped with the ACC-system (the “host vehicle”) and the leading vehicle are detected; and these parameters are used for the purpose of calculating an optimum distance and also a velocity that is to be maintained or rather is not to be exceeded for “following” the leading vehicle.

In order to provide the necessary data for an ACC-system of this type, radar sensors that amongst the sensors currently available in conjunction with active safety systems provide the best possible degree of accuracy are particularly suitable.

In order to further improve the performance of ACC-systems of this type, it is further known to use geolocation data related to the vehicles and also to include technologies of the “vehicle-to-vehicle” communication. However, since such “vehicle-to-vehicle” communication technologies are not yet in sufficiently wide-spread use, the relevant information required is not readily available for the time being for ACC-systems.

EP 1 292 462 B1 discloses inter alia a method for controlling the distance between a vehicle and a third vehicle that is travelling ahead, wherein the velocity of the vehicle and/or the desired distance to the third vehicle that is travelling directly ahead is set as a function of the distance between multiple third vehicles that are travelling offset to the side.

With regard to further prior art, reference is made merely by way of example to EP 0 871 898 B1, EP 2 251 240 A1, DE 10 2007 038 059 A1, DE 100 07 501 A1, EP 1 890 903 B1, DE 10 2007 057 722 A1 and EP 1 426 911 B1.

### SUMMARY

A method for employment in conjunction with an Adaptive Cruise Control (ACC) system of a vehicle as disclosed herein comprises operating a sensor to determine respective dynamic state variables of a leading vehicle forward of the vehicle and of a plurality of third vehicles; predicting future movements of the plurality of third vehicles by applying a swarm algorithm to a swarm comprising at least some of the plurality of third vehicles; and operating an ACC system based upon the variables and the future movements of the vehicles making up the swarm. The velocity of the vehicle and/or the distance between the vehicle and the lead vehicle (the third vehicle that is travelling directly ahead of the vehicle) is controlled by the ACC system.

The term “third vehicle” is used to distinguish any and all other vehicles in the vicinity of the host vehicle from 1) the host vehicle and 2) the leading vehicle, i.e. the vehicle that is travelling immediately forward of the host vehicle and in the same lane.

The concept of “swarm algorithms” used in particle swarm optimization is discussed and explained in “Particle Swarm Optimization,” Marco Dorigo et al., Scholarpedia, 3(11):1486., 2008, revision #91633, the disclosure of which is incorporated herein by reference.

In accordance with one embodiment, the swarm comprises a first sub-swarm analyzed using a first sub-swarm algorithm and a second sub-swarm analyzed using a second sub-swarm algorithm different from the first sub-swarm algorithm. The results obtained from the first and second sub-swarm algorithms may be combined to predict the future movements

In accordance with one embodiment, one of the first and second sub-swarms comprises a subset of the plurality of third vehicles located forward of the leading vehicle and in a traffic lane occupied by the leading vehicle.

In accordance with one embodiment, one of the first and second sub-swarms comprises a subset of the plurality of third vehicles located in a traffic lane adjacent to the traffic lane occupied by the leading vehicle.

In accordance with one embodiment, future movements of the third vehicles are predicted based on at least one of the following parameters: average distance of the sub-swarms, the moving state of the sub-swarms, inter-vehicle distances between the third vehicles, and respective individual movements of the third vehicles.

In accordance with one embodiment, a method of operating an adaptive cruise control system of a host vehicle comprises operating a sensor onboard the host vehicle to determine respective dynamic state variables of a plurality of second vehicles; applying a swarm algorithm to a swarm comprising at least some of the second vehicles to predict future movements thereof; and operating the vehicle based upon the variables and the predicted future movements.

In accordance with another embodiment, a method of operating an adaptive cruise control system of a host vehicle comprises operating a sensor onboard the host vehicle to determine respective dynamic state variables of a leading vehicle forward of the host vehicle and of a plurality of third vehicles; processing the dynamic state variables of a first subset of the third vehicles to predict future movements thereof using a first swarm algorithm; processing the dynamic state variables of a second subset of the third vehicles to predict future movements thereof using a second swarm algorithm different from the first swarm algorithm; and operating the vehicle based upon the variables and the predicted future movements of the third vehicles of the first and second subsets.

In other words, on the one hand the “traffic in the surrounding area” parameter relating to the convoy of third vehicles that are travelling ahead of the vehicle is used comprehensively or evaluated; on the other hand however all the third vehicles that are to be taken into consideration or rather detected using measuring technology are suitably sub-divided in order to ascertain and evaluate corresponding parameters for the vehicle movement and to predict the further traffic flow, wherein the parameters that are ascertained for the individual sub-swarms can be combined in an appropriate manner and used for the adaptive cruise control. The fact that multiple third vehicles that are also on the respective adjacent traffic lanes are detected or observed using measuring technology renders it possible to detect the traffic flow more accurately and for example to predict in advance the reaction to a specific third vehicle travelling in an adjacent traffic lane if a movement change of other third vehicles (travelling further ahead) is established, for example when vehicles brake as a result of a traffic jam.

In accordance with a further aspect, the invention relates to a device for adaptive cruise control of a vehicle, wherein dynamic state variables for a plurality of third vehicles are acquired using a sensor, and wherein the velocity of the vehicle and/or the distance between the vehicle and the third vehicle that is travelling directly ahead is set in dependence upon these acquired characteristic variables, wherein the device is designed so as to perform a method having the above described features.

### BRIEF DESCRIPTION OF THE DRAWINGS

FIG. 1 is a schematic depiction of a traffic situation on a three-lane motorway in the form of a recording of a moment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The host vehicle 10 that is performing the cruise control (i.e., the vehicle equipped with an ACC system) follows a leading vehicle 20 travelling directly and immediately ahead of the host vehicle. The velocity of the host vehicle 10 and/or the following distance between the host vehicle 10 and the leading vehicle 20 is set using the method disclosed herein. The middle traffic lane (in which the host vehicle 10 is travelling) is identified by the numeral “1”, the traffic lane that is lying to the left-hand side of the host vehicle 10 in the direction of travel is identified by the numeral “2” and the traffic lane that is lying to the right-hand side of the host vehicle 10 in the direction of travel is identified by the numeral “3”.

Using appropriate ACC radar sensor(s) (not illustrated) and signal processing, the host vehicle 10 detects, using technology of the general type well known in the art, leading vehicle 20 and other third-party vehicles 30-35 located in the vicinity of the host vehicle 10. The vehicles 20, 30-35 are detected by the ACC sensor(s) and resolved into discrete and respective “radar targets.” As is well-known in the art, the ACC system detects the dynamic state variables (e.g., location, velocity, acceleration) for each radar target identified by the sensor(s).

The term “third vehicle” is used to distinguish any and all other vehicles in the vicinity of the host vehicle from 1) the host vehicle and 2) the leading vehicle, i.e. the vehicle that is travelling immediately forward of the host vehicle and in the same lane.

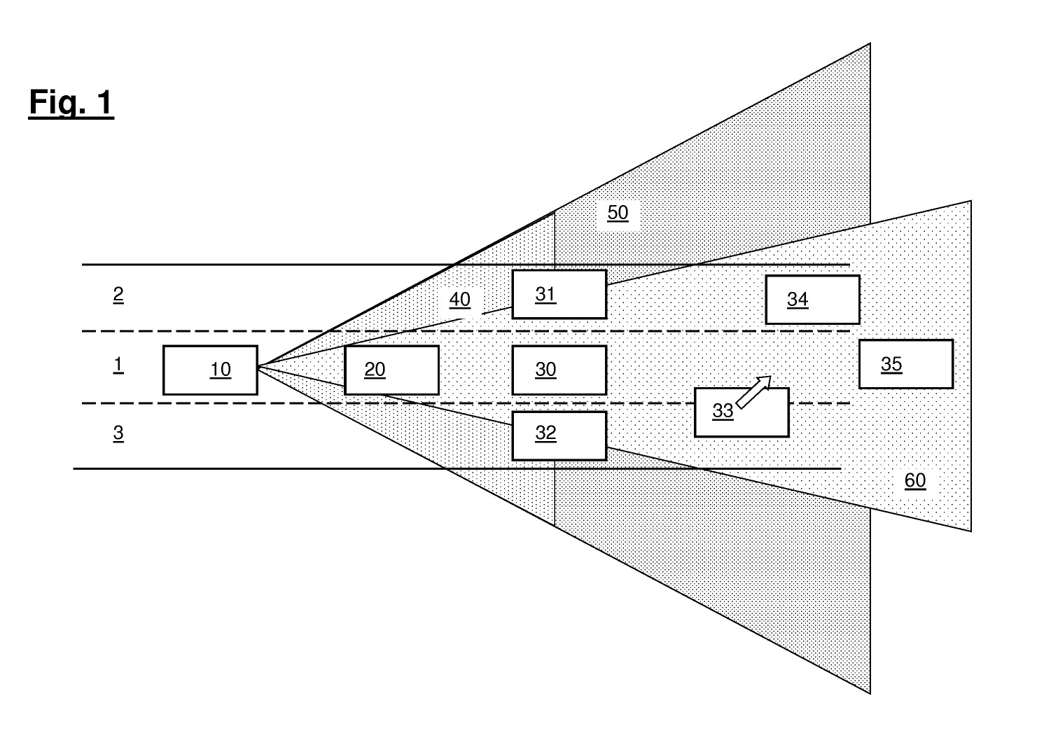

Respective regions are shaded differently in FIG. 1 to indicate a region 40 that can be directly monitored by a host vehicle ACC sensor(s), and also a region 60 that is hidden or “shadowed” by the leading vehicle 20 due to the line-of-sight nature of radar wave propagation. Third vehicles 30, 33, 34 and 35 are shown to be located in this hidden region 60.

The third vehicles 30, 33-35 are detected (and therefore used for evaluating or predicting future traffic situations) by means radar waves (those waves both originating from and returning to the host vehicle) that reflect off of the road surface. Generally speaking, the entire hidden region 60 can be monitored using the road-reflected radar waves.

It is known that a properly designed host-vehicle ACC radar system is able to detect vehicles that are forward of and otherwise concealed or hidden by a leading vehicle, in other words located in the “radar shadow” created by the leading vehicle. The vehicles located forward of the leading vehicle 20, although not directly detectable by the radar beam, can however as a result of reflections of the radar waves off of the road surface (that behaves to a certain extent as a mirror for the relevant frequencies) below the leading vehicle can be detected using measuring technology and for example can be evaluated during the course of a running time analysis and Doppler analysis. See, for example, U.S. Pat. No. 6,239,738B1, the disclosure of which is incorporated herein by reference.

The future movement of a third vehicle detected by of the host vehicle radar sensor may be predicted based on a swarm algorithm. The overall or “main” vehicle swarm that comprises all the detected third vehicles may be divided into sub-swarms comprising some portion or subset of the vehicles included in main swarm. The parameters or results obtained by applying an appropriate swarm algorithm to each of the sub-swarms may then be combined with one another and used by the ACC system of the host vehicle for vehicle control. It is possible on the basis of dividing the main vehicle swarm into sub-swarms to calculate the respective relevant parameters, for example in particular the relative distances between individual vehicles, the average distances of the sub-swarms and also the movements both of the individual vehicles and also of the respective sub-swarms.

The present disclosure also includes the method of dividing the entire “vehicle swarm” (comprising all third vehicles detected by the radar in the pertinent area adjacent to the host vehicle) into sub-groups or vehicle “sub-swarms”, for example accordingly into sub-regions of all the traffic lanes. The parameters ascertained or the results that are obtained by applying a swarm algorithm to one or more of the sub-swarms are then combined and used for the ACC. It is possible on the basis of dividing the vehicle swarm into sub-swarms to calculate the respective relevant parameters (for example, the relative distances between the individual vehicles, the average distances of the sub-swarms and also the movements both of the individual vehicles and also of the respective sub-swarms) with the result that the overall or total flow of traffic is detected more accurately and also an obstacle may be recognized at an early stage. By way of example, it is possible to predict even earlier the reaction to a third vehicle that is travelling ahead in the left-hand traffic lane if the respective third vehicles that are travelling head of this third vehicle change their movement (for example when vehicles brake as a result of a traffic jam).

The disclosed method employs the concept of taking into consideration a vehicle group referred to herein as a “vehicle swarm” or a cluster comprised of a plurality of third vehicles located ahead of (in the travel direction), alongside, or otherwise in the vicinity of the host vehicle and applying thereto a swarm algorithm. The “vehicle swarm” can comprise both third vehicles that are travelling ahead (to some extent in the “convoy”) and also third vehicles that are located at least in the adjacent traffic lane.

The above described process of observing the third vehicles 31-35 located in the traffic lanes 2, 3 adjacent to the travel lane 1 of the host vehicle 10 renders it possible to detect the traffic flow more accurately and to predict in advance, for example, the reaction of a specific vehicle travelling in an adjacent lane if a movement change of other vehicles (that are travelling further ahead), possibly when vehicles brake as a result of a traffic jam. FIG. 1 illustrates by means of an arrow, an exemplary avoidance steering maneuver of the third vehicle 33 from the right-hand traffic lane 3 to the middle traffic lane 1, wherein it is possible to react earlier to this avoidance maneuver or to the change as a result of this avoidance maneuver in the driving mode of the third vehicle 30 and also of the leading vehicle 20. As a consequence, softer acceleration or braking procedures by the host vehicle 10 leads to a more comfortable and also fuel-saving driving mode. Also, where appropriate, for example, more efficient control of a hybrid model vehicle may be achieved.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
operating a sensor to determine respective dynamic state variables of a leading vehicle forward of the vehicle and of a plurality of third vehicles;
predicting future movements of the plurality of third vehicles by applying a swarm algorithm to a swarm comprising at least some of the plurality of third vehicles; and
operating an adaptive cruise control system based upon the variables and the future movements.

2. The method of claim 1, wherein the swarm comprises a first sub-swarm analyzed using a first sub-swarm algorithm and a second sub-swarm analyzed using a second sub-swarm algorithm different from the first sub-swarm algorithm.

3. The method of claim 2, wherein results obtained from the first and second sub-swarm algorithms are combined to predict the future movements.

4. The method of claim 2, wherein one of the first and second sub-swarms comprises a subset of the plurality of third vehicles located forward of the leading vehicle and in a traffic lane occupied by the leading vehicle.

5. The method of claim 2, wherein one of the first and second sub-swarms comprises a subset of the plurality of third vehicles located in a traffic lane adjacent to the traffic lane occupied by the leading vehicle.

6. The method of claim 2 wherein future movements of the third vehicles are predicted based on at least one of an average distance of the sub-swarms, a moving state of at least one of the sub-swarms, an inter-vehicle distances between a pair of the third vehicles, and respective individual movements of the third vehicles.

7. The method of claim 1, wherein at least one of the third vehicles is located in a region that is blocked from direct detection by the sensor.

8. A method of operating an adaptive cruise control system of a host vehicle comprising:
operating a sensor onboard the host vehicle to determine respective dynamic state variables of a plurality of second vehicles;
applying a swarm algorithm to a swarm comprising at least some of the second vehicles to predict future movements thereof; and
operating the vehicle based upon the variables and the predicted future movements.

9. The method of claim 8, wherein the swarm comprises a first sub-swarm analyzed using a first sub-swarm algorithm and a second sub-swarm analyzed using a second sub-swarm algorithm different from the first sub-swarm algorithm.

10. The method of claim 9, wherein results obtained from the first and second sub-swarm algorithms are combined to predict the future movements.

11. The method of claim 9, wherein one of the first and second sub-swarms comprises a subset of the plurality of second vehicles located forward of and in a traffic lane occupied by the host vehicle.

12. The method of claim 9, wherein one of the first and second sub-swarms comprises a subset of the plurality of second vehicles located in a traffic lane adjacent to the traffic lane occupied by the host vehicle.

13. The method of claim 9 wherein the future movements are predicted based on at least one of an average distance of the sub-swarms, a moving state of at least one of the sub-swarms, an inter-vehicle distances between a pair of the third vehicles, and respective individual movements of the third vehicles.

14. The method of claim 8, wherein at least one of the second vehicles is located in a region that is blocked from direct detection by the sensor by a vehicle directly forward of the host vehicle.

15. A method of operating an adaptive cruise control system of a host vehicle comprising:
operating a sensor onboard the host vehicle to determine respective dynamic state variables of a leading vehicle forward of the host vehicle and of a plurality of third vehicles;
processing the dynamic state variables of a first subset of the third vehicles to predict future movements thereof using a first swarm algorithm;
processing the dynamic state variables of a second subset of the third vehicles to predict future movements thereof using a second swarm algorithm different from the first swarm algorithm; and
operating the host vehicle based upon the variables and the predicted future movements of the third vehicles of the first and second subsets thereof.
